(19) United States
(12) Patent Application Publication
(10) Pub. No.: US 2003/0074288 A1
(43) Pub. Date: Apr. 17, 2003

(54) System and method for electronically reconciling financial accounts

(75) Inventor: Douglas B. Quine, Bethel, CT (US)

Correspondence Address: Pitney Bowes Inc., Intellectual Property and Technology Law Dept., 35 Waterview Drive, P.O. Box 3000, Shelton, CT, 06484, US

(73) Assignee: Pitney Bowes Incorporated, Stamford, CT (US)

(21) Appl. No.: 09/975,403

(22) Filed: Oct. 11, 2001

(51) Int. Cl. G06F 17/60

(52) U.S. Cl. 705/33

(57) ABSTRACT

A system and method for electronically emulating banking statements and reconciling banking statements using the world-wide-web or Internet. A computer server is provided at a bank site for serving a plurality of remote bank customers. Each customer logs-on to the server using a pre-designated username or account number and a password for authentication. After a successful log-on to the banking server, the customer may request his or her bank statement to be displayed. In the event the customer wishes to reconcile his or her account, an electronic emulation of the bank statement reconciliation form (RF) is presented to the customer. If the RF is not complete with customer account data, then the customer is enabled to add information to the RF. The RF automatically imports data from the customer account to which it is linked. Subsequently, the banking server performs all reconciling calculations associated with balancing the customer account, and reconciled data is displayed to the customer.

### FIELD OF THE INVENTION

The present invention relates to reconciliation of financial records. More particularly, it relates to a system and method for electronic reconciliation of financial accounts/bank statements.

### BACKGROUND OF THE INVENTION

Time is fast approaching where a significant amount of commerce will be conducted using distributed networks of computers such as the Internet. This ground swell of commerce will be driven by the ability of merchants to economically reach a vast number of potential customers.

Customers traditionally balance a checkbook by carefully entering all transactions in a ledger as they occur. Hardcopy paper checking account statements have an account reconciliation form on the back of the statement to allow the customer to manually balance the account. This includes entering debits, such as uncleared checks, ATM withdrawals, finance charges, bank charges, automatic debits, and merchant debit payments since the statement was created, to name but a few. There is also provision for entering new credits, such as recent deposits and electronic credits.

Upon receiving a monthly statement, reconciliation of the monthly paper statement is a multistep process. Specifically, the account holder copies the balance on the face of the statement to the reconciliation form. One is required to enter and add all deposits in the checkbook register. Such information may include interest, electronic transfer credits, recent deposits, and other ATM deposits that appear on the bank statement. Next, the user subtotals the statement balance and the pending deposits. The amounts of checks outstanding (for example, checks that one has recorded but do not appear on one's statement) are itemized. When the pending checks are subtracted from the subtotal to show the current account total balance, the total should agree with the checkbook balance after the user enters and subtracts from the checkbook register any changes on the statement not yet deducted from the register. Such deductions may include, for example, charge for checks, service charge, electronic transfer charge or unrecorded ATM withdrawal fees. The above approach is generally depicted in FIG. 1.

Despite the ready availability of sophisticated hardware and software for conducting a plethora of financial transactions including the above described reconciliation process, the ordinary task of monthly checkbook balancing and rectification remains inordinately difficult and tedious. In fact, the task of comparing a balance of checks and deposits as recorded on a bank statement with a checkbook balance is so burdensome that many users of checking accounts simply accept the bank statements as correct and ignore any discrepancies. It is clear from the foregoing that there is a need for an efficient methodology and system to automatically reconcile banking statements over distributed computer networks and using the World Wide Web.

### SUMMARY OF THE INVENTION

Accordingly, the present invention relates to a system and method for electronically emulating banking statements and reconciling banking statements using the world-wide-web. The present invention may be well suited for individuals receiving banking statements electronically.

In a preferred embodiment, the present invention includes a computer server located at a bank site for serving a plurality of remote bank customers. Customers log-on to the banking server using a pre-designated username or account number and a password. After a successful log-on to the banking server, the customer may request his or her bank statement to be displayed on the customer's display device. In the event the customer wishes to reconcile his or her account, an electronic emulation of the bank statement reconciliation form (RF) is presented to the customer. The RF is an active form or spreadsheet linked to the customer's account or demand deposit statement. The RF automatically imports data from the customer account to which it is linked. Further, the application running the RF uses a “wizard” approach (for inexperienced users) to walk the customer through a series of steps for entry of uncleared checks and unrecorded deposits. More experienced users may choose to make the entries in their own sequence. Subsequently, the banking server performs all reconciling calculations associated with balancing the customer account.

In another embodiment, a customer may initiate the process of reconciling his or her account upon receiving an electronic banking statement from the customer's financial institution in the form of an electronic message. Alternatively, the customer may request account reconciliation pro-active at any time even in the absence of any communication from the financial institution.

It will be appreciated that the details of communication protocols in order to enable a remote bank customer (client) to connect to the bank server (server) are not described in great detail here. Any communication protocols used in packet switched networks in order to enable client-sever communication may be used for the present invention. Therefore, the present invention should not be construed to be limiting of any particular protocol or hardware interfaces for establishing such communication between a client and a server.

It will further be appreciated that the present invention should not be construed as limiting to a particular type of network. Although, terms such as world wide web (www), Internet, and packet switching network are alternatively used, the present invention is not limiting of any one of those networks. The remote customer computer need not necessarily be a computer. Any hand-held device, such as a PDA, cell-phone, WebTV, or other interactive electronic device, that can access, process, and display remote data may be used.

Still other objects and advantages of the present invention -will become apparent to those skilled in the art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

The above and other objects and advantages of the present invention will become more readily apparent upon consideration of the following detailed description, taken in conjunction with accompanying drawings, in which like reference characters refer to like parts throughout the drawings and in which:

FIG. 1 illustrates a form for reconciling bank statements using a traditional approach;

FIG. 2 illustrates a schematic for communicatively coupling remote bank customers with a bank server via a worldwide web in accordance with an example embodiment of the present invention;

FIG. 3 is a detailed schematic of the bank server as identified in FIG. 2;

FIG. 4 is a detailed schematic of a bank customer terminal as identified in FIG. 2;

FIG. 5 is a process flow chart for performing reconciliation process in accordance with an example embodiment of the present invention;

FIGS. 6-7 illustrate various embodiments for enabling communication between remote customers and a server of a financial institution as identified in FIG. 2.

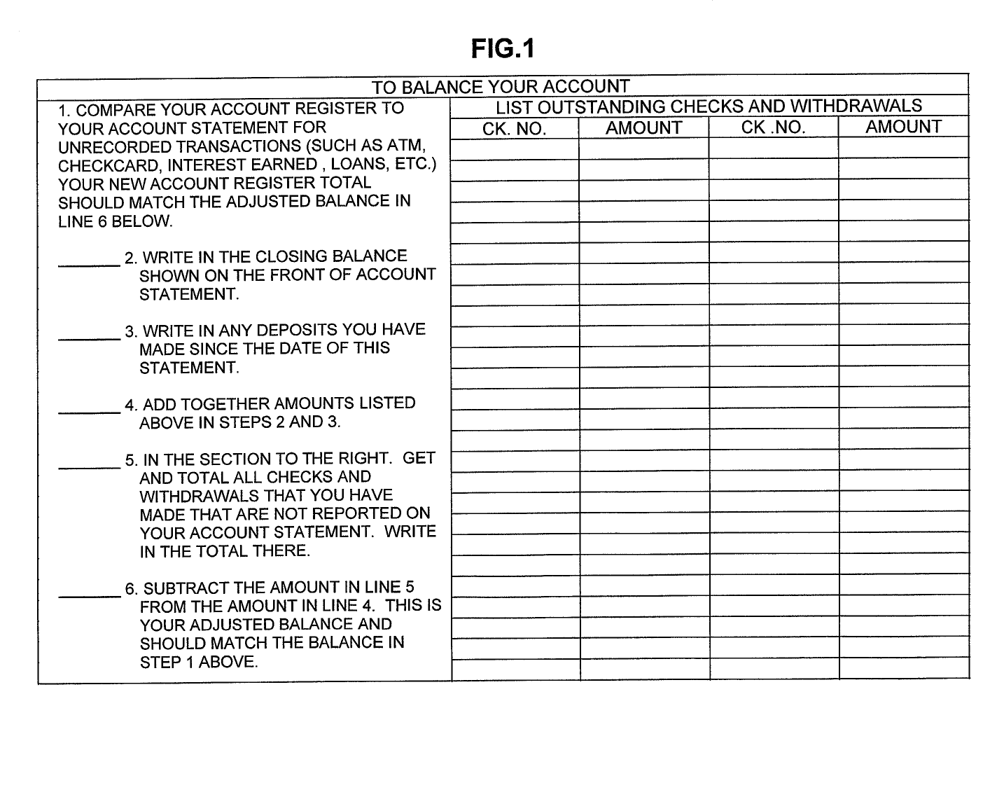

### DETAILED DESCRIPTION OF THE INVENTION

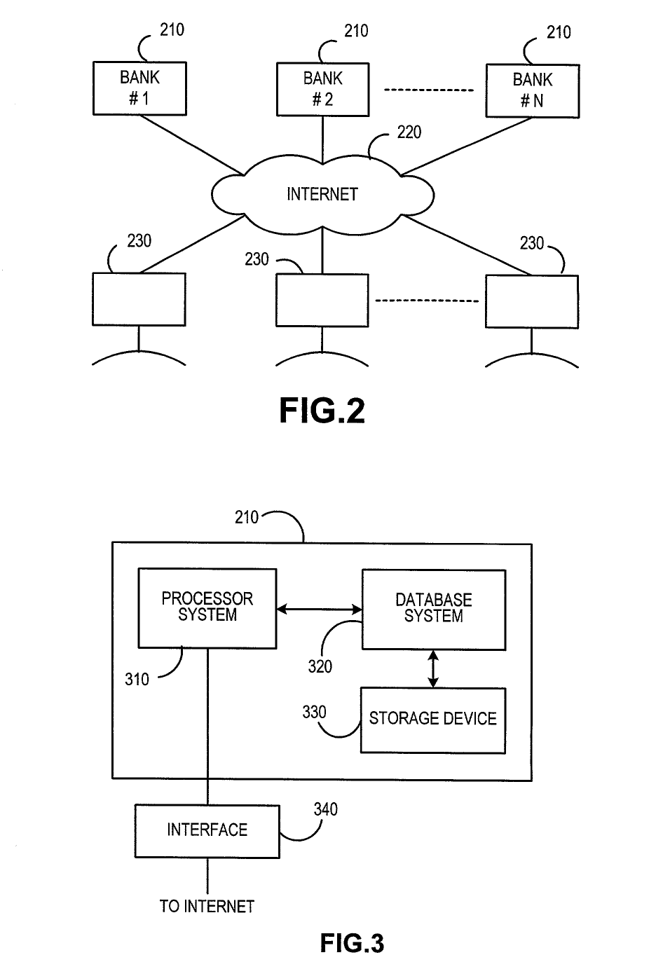

Referring to FIG. 2, there is shown a schematic 200 for communicatively coupling remote customers 230 with a server 210 via a worldwide web/internet 220. The present schematic discloses only three server computers and three customer terminals for the sake of brevity. In fact, any number of customers may connect to any number of server computers. In one embodiment, the remote customers may log-on to a server 210 via an Internet protocol (IP) interface via the worldwide web. Each server 210 may be provided with Internet protocol (IP) address in order to enable remote customers log-on to the server.

As illustrated in FIG. 2, server 210 may send banking statements through Internet 220 to remote customers 230. This mechanism parallels the current paper based system in which the bank statements are provided automatically to the remote customer 230 without any proactive action required by the customer. Each of the remote customers 230 and each of the servers 210 are installed with client-server communication hardware (e.g., web browsers) and software interfaces (e.g., JavaScript) in order to enable communication between the customers and the server, and computations at the client site.

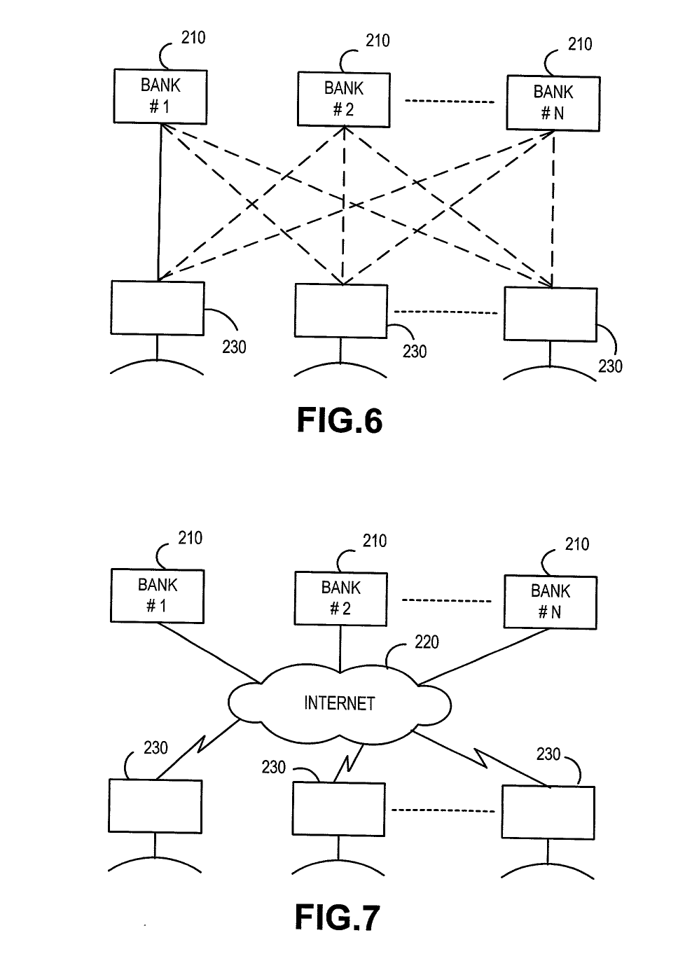

In another embodiment, as illustrated in FIG. 6, remote customers 230 may log-on to a server 210 by directly dialing into the server 210. Each of the remote customers 230 and each of the servers 210 are installed with client-server communication hardware and software interfaces in order to enable communication between the customers and the server.

In yet another embodiment as illustrated in FIG. 7, it is also envisioned to use wireless communication protocols in order to enable remote customers 230 to connect to a server 210 via the worldwide web. The details of specific protocols are not discussed herein for the sake of brevity. Any presently used wireless access protocols, such as for example, wireless access protocols may be used. The present invention is not limited to any specific protocol.

FIG. 3 shows a detailed schematic of the server as identified in FIG. 2. Each server 210 includes a processor system 310 for processing account information, a database system 320 for organizing customer data, and a storage device 330 for storing customer data and account related information. Each server 210 is coupled to an interface device 340 in order to enable communication with remote customers via worldwide web/internet 220. Each server 210 is further loaded with application software required to perform tasks related to a financial institution. For example, each server may be loaded with application software to perform banking related tasks including reconciling customer accounts. The application software may be programmed to provide and display account information to customers in the form of various user interface templates. Likewise, a customer may be provided with a user interface template in order to update banking records with uncleared and unrecorded customer transactions.

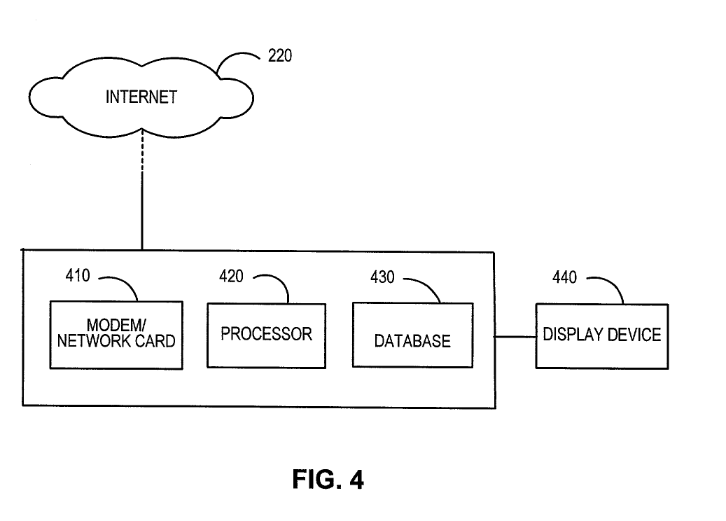

FIG. 4 shows the details of a customer terminal that is used to enable remote customers connect to a server 210 of a financial institution as illustrated in FIG. 2. Each customer terminal 230 may include a modem or a network card 410 for enabling the terminal 210 (FIG. 2) to connect to the Internet 220. Alternately, the modem 410 may be used to directly dial and log-on to the server 210 (FIG. 2). Each customer terminal may further include a processor 420, a database 430, and a display device 440 in order to display account related information generated by a server 210 (FIG. 2). Each server 210 (FIG. 2) may be equipped with password based access controls and encryption software in order to ensure secrecy of the customer data, and likewise, each valid customer may be provided with personal passwords and decryption information that would enable the customer to view respective account related information.

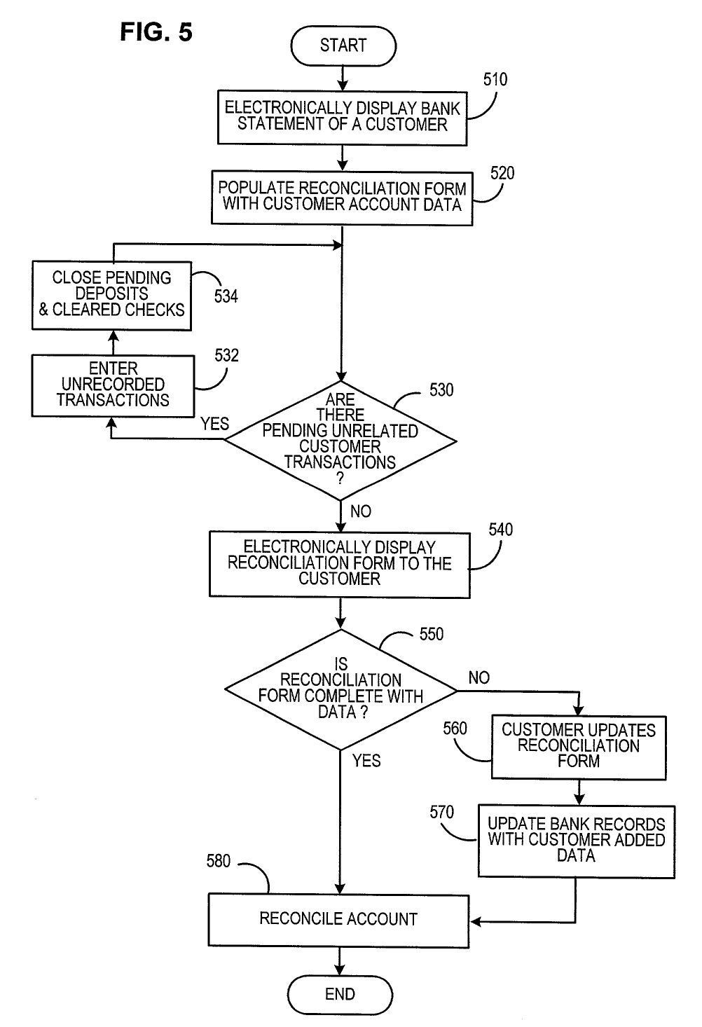

Referring to FIG. 5, there is shown a process flow chart for performing reconciliation process in accordance with an example embodiment of the present invention. In operation, a server 210 (FIG. 2) processes the account related data of a customer in order to create a monthly banking statement. The account related data includes, for example, checks written by a customer, deposits, ATM withdrawals and associated fees, and other credits and debits. The monthly bank statement is presented electronically to a user, as indicated at step 510, who successfully logs onto the server using a pre-designated username and password information. In the event of identifying other pending or unrecorded customer transactions that were not identified at the time of creating the bank statement, those transactions are identified in step 530, flagged as in step 532. It should be noted that step 532 may include multiple data entries, and step 532 loops back to step 530 where unrecorded customer transactions are identified, until all data is entered. Any pending deposits and cleared checks are cleared as in step 534, and a revised bank statement is displayed to the customer.

If the user wishes to reconcile the bank statement, a reconciliation form (RF) populated with the account related data of the customer and then displayed to the customer at step 540. A determination is made to find out whether or not the RF is complete with customer data at step 550. If RF is complete with customer data, then the customer account is reconciled at step 580 and the reconciliation result is displayed to the customer, and the process ends. In the event that the RF is not complete with customer account data, the customer updates the RF, for example, with all new checks and deposit information that have not cleared. This new information entered by the customer is taken into consideration in order to recalculate the account balances and the RF subtotals for each of the fields. The bank or financial institution records are appropriately updated with the new information entered by the customer as indicated at step 570 so that the customer does not have to reenter the pending deposit and check information during the following month, and the customer account is subsequently reconciled as indicated at step 580. This reconciliation process may be repeated on a monthly basis or as often as the customer wishes to view their account status.

In summary, electronic emulation of the statement reconciliation form would be an active form or spreadsheet (for example, javaScript or ASP) linked to the customer account. The reconciliation form would automatically provide the latest balance from the statement and then use a “wizard” approach (inexperienced users) to walk the customer through entry of uncleared checks and unrecorded deposits. More experienced users may choose to make the entries in their own sequence. The customer could connect to their account through the internet, or through direct dial to the financial institution server, view their account, and allow the server to perform all customer account related calculations including balancing the account once the customer enters the requested data. Absent this feature, on-line statement presentations result in remote printing of the statement, thus the customer does not derive benefit from the processing power of the server nor of their local computer. A paperless option may not therefore be achieved.

Other value added features of the present invention include (i) using the “wizard” approach to suggest possible was to resolve unexplained account balance discrepancies (for example, listing nearest dollar value items to the discrepancy such as a cashed check that was being reported as uncashed); (ii) using previous month balancing information to pre-populate the reconciliation form; (iii) automatic updating of previous month data (for example, checks cleared, or deposits recorded); (iv) warning the customers about account irregularities (for example, e-mail message using internet, or sending a paging message); (v) completing on-line check book register; (vi) internet or streamlined WAP-WML (wireless access protocol -wireless markup language) connectivity through 2-way pagers to add new checks to the on-line check book register, to name but a few.

The above description of the preferred embodiments is provided to enable a person skilled in the art to make and use the present invention. As aforementioned, the various modifications to these embodiments will be readily apparent to those skilled in the art and the generic principles defined herein can be applied to other embodiments without the use of the inventive faculty. Thus, the present invention is not intended to be limited to the embodiments shown herein but is to be accorded the widest scope consistent with the principles and novel features disclosed.

What is claimed is:

1. In a system for automatically reconciling account data of a customer, the system having one or more server computers coupled to internet, one or more remote computers for accessing the one or more server computers, a method of automatically reconciling a customer account comprising:
a) electronically displaying a bank statement of a customer on a display device of the customer;
b) retrieving a reconciliation form from a server computer, the reconciliation form linked to a bank statement of the customer;
c) populating the reconciliation form with customer account data; and
d) performing account reconciliation tasks if the reconciliation form is complete with customer account data.

2. The method as in claim 1, wherein step (b) further comprises:
b1) enabling a customer to add information to the reconciliation form if the form is not complete with customer account data; and
b2) retrieving a reconciliation form from a server computer and storing said retrieved reconciliation form in respective remote computers.

3. The method as in claim 1, wherein step c) further comprises:
c1) updating financial institution records with information added by the customer to the reconciliation form.

4. The method as in claim 1, wherein step a) further comprises:
a1) determining if there are ongoing transactions related to a customer's account;
a2) identifying the ongoing transactions; and
a3) performing tasks to close pending deposits and cleared checks of the customer.

5. The method as in claim 1, wherein the reconciliation form is a spreadsheet.

6. The method as in claim 1, further comprising:
a) issuing warnings to a customer in the event of identifying irregularities in the customer's account.

7. The method as in claim 6, further comprising:
a) providing an on-line register, said register stored in one or more server computers; and
b) enabling a customer to add new checks to said register.

8. A financial transaction system for automatically reconciling customer accounts, the system comprising:
one or more server computers for storing and processing customer account data;
a plurality of customer computers remote from said one or more server computers, said customer computer and said one or more server computer communicatively coupled via internet;
each said server computer having automatic means for processing and communicating customer account data with a respective customer computer via said internet, each said server computer further receiving instructions from one or more customer computer for reconciling respective customer accounts, each said server having automatic means responsive to the instructions for:
a) electronically displaying a bank statement of a customer on a display device of the customer;
b) retrieving a reconciliation form from a server computer, the reconciliation form linked to a bank statement of the customer;
c) populating the reconciliation form with customer account data; and
d) performing account reconciliation tasks if the reconciliation form is complete with customer account data.

9. The system as in claim 8, further comprises:
means for enabling a customer to add information to the reconciliation form if the form is not complete with customer account data,

10. The system as in claim 8, further comprises:
means for updating financial institution records with information added by the customer to the reconciliation form.

11. The system as in claim 8, further comprises:
means for determining if there are ongoing transactions related to a customer's account;
means for identifying the ongoing transactions; and
means for performing tasks to close pending deposits and cleared checks of the customer.

12. The system as in claim 8, wherein the reconciliation form is a spreadsheet.

13. The system as in claim 8, further comprising:
means for issuing warnings to a customer in the event of identifying irregularities in the customer's account.

14. The system as in claim 8, further comprising:
means for providing an on-line register, said register stored in one or more server computers; and
means for enabling a customer to add new checks to said register.

15. A system for automatically reconciling account data of a customer, the system comprising:
one or more server computers for storing customer data, each server communicatively coupled to a packet switching network;
one or more remote computers for accessing said on or more server computers via internet;
means for electronically displaying a bank statement of a customer on a display device of the customer;
means for retrieving a reconciliation form from a server computer, the reconciliation form linked to a bank statement of the customer;
means for populating the reconciliation form with customer account data; and
means for performing account reconciliation tasks if the reconciliation form is complete with customer account data.
